(19) United States
(12) Patent Application Publication
(10) Pub. No.: US 2017/0105367 A1
(43) Pub. Date: Apr. 20, 2017

(54) DEVICE FOR COLLECTING SAP

(71) Applicant: MI INTÉGRATION S.E.N.C., Sherbrooke (CA)

(72) Inventors: Yves RENE, Ham-Nord (CA); Claude HOULE, Austin (CA)

(21) Appl. No.: 15/297,485

(22) Filed: Oct. 19, 2016

Related U.S. Application Data
(60) Provisional application No. 62/243,180, filed on Oct. 19, 2015.

(51) Int. Cl. A01G 23/14

(52) U.S. Cl. CPC A01G 23/14

(57) ABSTRACT

There is provided a sap collecting device that is configured to be fastened into a tap hole of a tree.

### RELATED APPLICATIONS

This application claims priority from, U.S. Provisional Patent Application 62/243,180 filed Oct. 19, 2015, the entirety of which is incorporated herein by reference.

### TECHNICAL FIELD

This invention relates generally to devices for collecting sap.

### BACKGROUND

Devices for collecting sap are well known in the art. They usually consist of a spout having a tree inserting part and an outside conduit for directing the collected sap to a reservoir or sap collecting tubes.

These spouts are inserted in the tree after a tap hole of the appropriate dimensions, that is to say roughly the size of the part of the spout that is inserted in the tree, has been made.

There are a number of problems with such spouts. First they tend to be pushed out of the tree when the temperature varies (freeze and thaw) requiring that they be pushed back in. This step is actually a manual step that is done using a hammer and is therefore a time consuming operation and furthermore one that creates damage to the spout and the tree every time it is pushed back in. Loose spouts are an important source of vacuum leaks in modern sap collecting systems which rely on a vacuum to increase the yield. Checking and fixing loose spouts is time consuming.

Furthermore, the depth of spout insertion within the tree (within the tap hole) is very roughly controlled by the force applied to the hammer.

Spouts exist that comprise a fastener for maintaining the spout in the tree. For example U.S. Pat. Nos. 74,101 and 930,361 describe such spouts. Other spouts with integrated fastening parts are known (U.S. Pat. No. 144,871, U.S. Pat. No. 225,762, U.S. Pat. No. 2,958,158, U.S. Pat. No. 4,884,365, U.S. Pat. No. 4,926,597). However these spouts suffer from a number of drawbacks. First they generally lack proper seal at the fastener inserting end, allowing some sap leakage and loosening of the fastener over time. The lack of a proper seal also results in an inefficient vacuum when sap is collected under vacuum as it is in most modern installations. Others have a complicated design that makes the insertion in the tree difficult. Some sap collecting devices with fasteners require a bark abutting component or surface that cooperates with the fastener to maintain the position of the spout which can result in damage to the tree. Furthermore the sap flows through an opening located on this bark abutting component which forces the sap to be continuously in contact with the fastener loosening the fastener through freeze-thaw cycles.

Finally some of the spouts described in the above cited patents are made of metal. Nowadays spouts are made of plastic and metal models with fasteners such as those of the prior art are unsuitable for plastic spouts.

Modern spouts on the market do not have fasteners and therefore must be inserted relatively deep in the tree to be retained therein. This actually imposes a lower limit on the size of the spouts since spouts with a tree inserting part that is too short will not remain solidly inserted. As smaller spouts are desirable to minimize damage to the tree, there is a need for better sap collecting devices.

### SUMMARY

In one aspect of the invention there is provided a device for collecting sap from a tree, comprising: a first bore-comprising member, the first member comprising a tap hole inserting end and a fastener receiving end, a second bore-comprising member fluidly connected to the first member at a point between said tap hole inserting end and the fastener receiving end and adapted to be connected to sap collecting tubing, and wherein the fastener receiving end comprises an opening communicating with the bore of the first member and configured to sealingly collaborate with a fastener, the fastener adapted to fit in the bore and extend beyond the first member to fasten the device in the tap hole while allowing sap to flow in the first bore-comprising member and into the second bore-comprising member.

In another aspect there is provided a sap collecting device kit comprising a sap collecting device as described above, and a fastener configured for the sap collecting device.

In yet another aspect there is provided a sap-collecting system comprising a sap collecting device as describe herein, a fastener for fastening said sap collecting device to a tree, and a sap collecting tubing adapted to be fluidly connected to said sap collecting device and to a vacuum generator.

Advantageously, the sap collecting device of the invention enables higher efficiency vacuum in sap collecting system operating under vacuum to increase collection yield by preventing the device from disengaging from the tap hole in which it is inserted through its fastening mechanism and also by providing a tight seal in the fastener receiving end of the device to prevent vacuum leak.

In another aspect of the invention there is also provided method of producing maple syrup comprising preparing a tap hole in a maple tree; inserting a sap collecting device into the tap hole to fill only an outer portion of the tap hole; inserting a fastener passing through a bore of the sap collecting device to lodge in an end of the tap hole to fasten the sap collecting device in the tap hole; sealing the sap collecting device and drawing through a vacuum hose maple sap from the maple tree; and concentrating the maple sap to produce a syrup.

### BRIEF DESCRIPTION OF THE DRAWINGS

The invention will be better understood by way of the following detailed description of embodiments of the invention with reference to the appended drawings, in which:

FIG. 1 is a cross-sectional view of an embodiment of the sap collecting device of the invention.

FIG. 2 is a perspective view of an embodiment of the sap collecting device of the present invention.

FIG. 3 is a cross-sectional view of an embodiment of the sap collecting device of the invention with a fastener.

FIG. 4 is a cross-sectional view of an embodiment of the sap collecting device of the invention showing the fastener receiving end portion.

FIG. 5 is a horizontal cross-sectional view of a tree showing an embodiment of the sap collecting device of the invention in comparison to a sap collecting device of the prior art.

### DETAILED DESCRIPTION

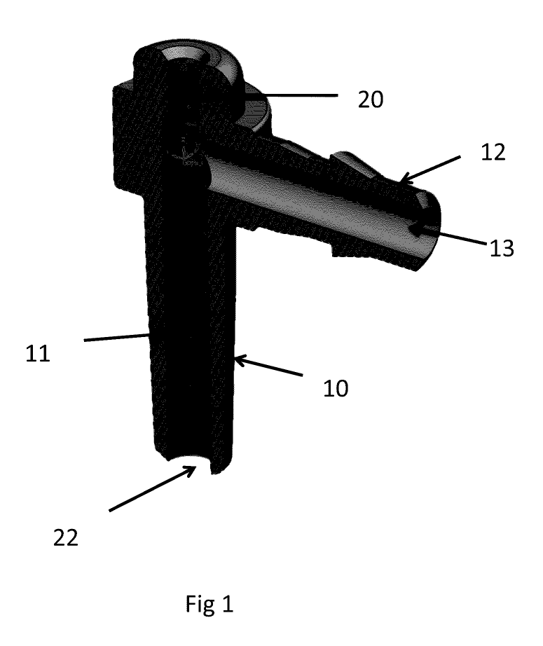

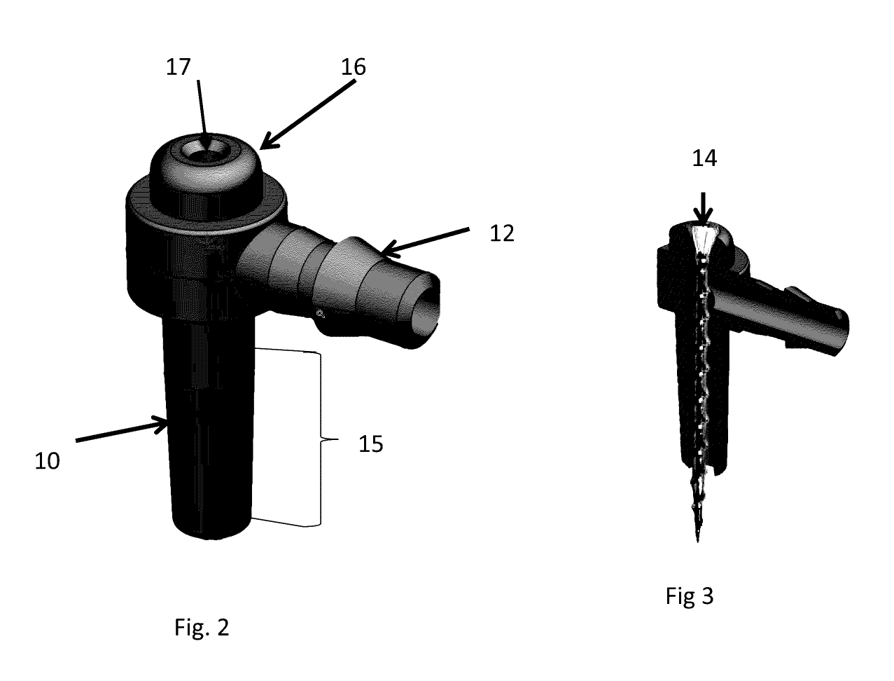

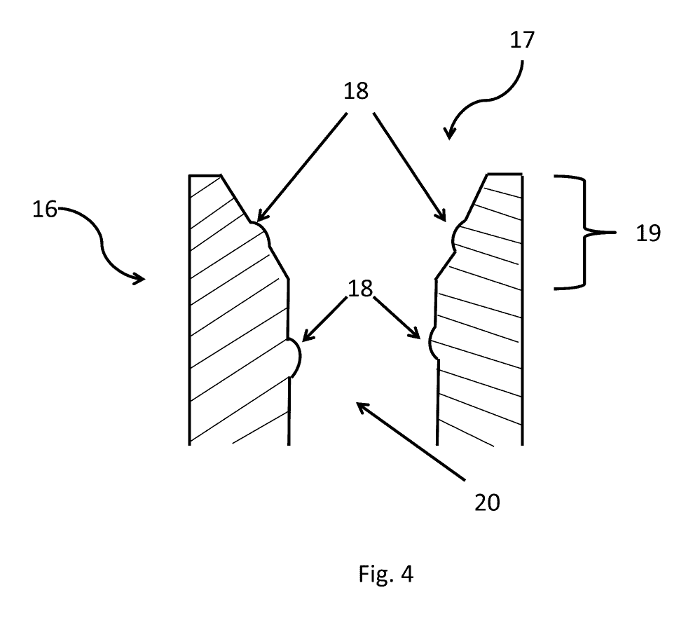

With reference to FIGS. 1 and 2 there is provided a sap collecting device that can be inserted in a tap hole of a tree to collect sap through a first member 10 having a bore 11 to channel the sap into a second member 12 also comprising a comprising a bore 13 from where the sap is finally collected in a reservoir or a tubing system. The sap collecting device of the invention is maintained in place in the tap hole by a fastener 14 (an example of which shown in FIG. 3) the functioning and configuration of which will be explained further below.

The first member comprises a first tap hole inserting end 15 and at the opposite end of the generally elongated first member is the fastener receiving end 16. In one aspect of the invention the fastener is a screw or a nail or some other elongated fastener means that is inserted through opening 17 at the fastener receiving end and within the bore 11 of the first member and extends beyond the first member to penetrate the tree at the end of the tap hole when the device is inserted therein.

The fastener receiving end is shaped or configured to sealingly collaborate with the fastener to provide a tight seal preventing the sap from leaking out and preventing vacuum leaks when the collection of the sap is performed under vacuum. For example, the fastener receiving end can have a cone shape or nested configuration for receiving a matching cone shaped end of the fastener as shown in FIG. 3.

The fastener receiving end can also comprise one or more sealing member(s) such as O-rings or ribs 18 (FIG. 4). The ribs may be located at different places in the fastener receiving end depending on the configuration of the fastener receiving end and the fastener head. In one embodiment, the fastener receiving end comprises a fastener head receiving portion 19 that is cone shaped (FIG. 4) which comprises one or more ribs.

In another embodiment, sealing ribs can be located along the bore of the fastener receiving end (below the fastener head receiving portion 19).

It will be appreciated that both the fastener head receiving portion 19 and the bore of the fastener receiving end may comprise sealing ribs.

The sealing ribs may be of the same plastic material as the rest of the spout structure, forming a single structure or they may be made of different material such as rubber and inserted or over-molded in the fastener receiving end.

The fastener can sealingly collaborate with the sealing member(s) by a sealing contact deformation of the sealing member(s) to generate a sealing contact conformation with the fastener as a result of the pressure applied by the fastener onto the sealing member through the torque or force applied to secure the fastener. In this respect the sealing member may also be any part of the fastener receiving end such as the section comprising the bore in the fastener receiving end or the fastener receiving end portion 19.

Alternatively or in addition to, the fastener may also comprise sealing member(s) integrated on the fastener such as self-sealing fasteners. It will be appreciated that other configurations are possible for the fastener receiving end and the fastener itself that can provide suitable sealing.

The tight seal at the fastener receiving end contributes to increase the efficiency of the vacuum when the collection of the sap is performed under vacuum.

The first member 10 at the inserting end may be shaped to facilitate insertion and reduce damage to the tree. For example the end of the first member near the sap collecting opening 22 may be rounded or angled (tapered) as shown in FIGS. 1 and 3.

The second member 12 is fluidly connected to the first member 10 and is located between the tap hole inserting end 15 and the fastener receiving end 16. When the device is inserted and fastened in the tap hole the second member is not compressed against the tree so as to prevent damage to the tree and allow for easy attachment of sap collecting tubing to second member 12. This configuration of the first and second member also provides for easy access to the fastener receiving end to facilitate the insertion or removal of the fastener.

In one embodiment, the fastener receiving end 16 comprises a fastener receiving end bore section 20 wherein the diameter of the bore is smaller than the rest of the bore of the first member 10. The diameter of the bore in this section is preferably about the diameter of the fastener or slightly less. This geometry advantageously provides for a better seal by substantially preventing (or reducing) the sap from reaching the seal area which could otherwise create damage to the seal when the device is subjected to period of freeze-thaw cycles. Furthermore the fastener receiving end boresection 20 provides increase stability of the fastener when it is inserted and installed by reducing wobbling of the fastener within the bore. The fastener receiving end bore section 20 may also serve as a sealing member. For example, with a bore diameter in this section that is slightly less than the fastener, a tight seal is formed by the sealing contact deformation of the inner surface of the bore created by the insertion of the faster. For example, when a screw is used, by creating a thread in the surface of the bore that espouses the shape of the threads of the screw.

The length of the fastener receiving end bore section 20 may vary according to the type of fastener, the length of the first member, the position of the second member and the type(s) of sealing members. Accordingly the length of the fastener receiving end 16 may also vary. It will also be appreciated that the narrowing of the bore in the fastener receiving end bore section 20 can create a pressure buildup in the flow of sap coming from the tree thereby encouraging the flow to proceed in the second member 12. Thus in one embodiment it is preferred that the second member 12 be located closer to the fastener receiving end than the tap hole inserting end.

In one embodiment the fastener does not occupy the whole volume of the bore 11 in the tap hole inserting end 15 so as to let the sap flow towards the second member. Also the fastener may comprise means for facilitating sap collection such as grooves or holes therein that are configured on the fastener to fluidly collaborate with the sap collecting opening 22. These means for facilitating sap collection may also be configured so as to improve the seal at the fastener receiving end. For example the grooves or holes may reach the area of the second member but not further, that is to say not extending in the fastener receiving end bore section 20 area so as to avoid the accumulation of sap in the seal areas.

It will be appreciated that, in another embodiment, the diameter of the bore in the fastener receiving end bore section 20 may be similar or identical to the diameter of the bore in the tap hole inserting end 15 section of the first member 10. In the case where diameters of the bores in the fastener receiving end bore section 20 and the tap hole inserting end 15 section are the same and that this diameter is slightly less than the diameter of the fastener to create a sealing member with the inner side of the bore, the fastener comprises means for facilitating sap collection as described above.

While the device does not have to be made of plastic, it will be appreciated that plastic is a preferred material since it is more economical to produce and allows for easy design and manufacture. Currently used plastic spouts are not adaptable to comprise fasteners. The present invention provides a spout design that enables plastic spouts to be used in conjunction with fasteners.

The penetration of the first member 10 in the tap hole can be limited by the back side of the tap hole in the tree. Alternatively, the first member 10 can have a frusto-conical shape tapering off along the tap hole inserting end 15 and having an increasing diameter away from the sap collecting opening 22 such that at some position along the first member 10 the diameter is greater than the diameter of the tap hole thereby providing frictional resistance as the first member is inserted in the tap hole and the device fastened into the tree. This frusto-conical shape enables a control over the depth of penetration within the tree. The depth of penetration of the first member can thus be adjusted or predetermined by the steepness of the tapering off of the first member. The tapering off need not be regular in the sense that the steepness of the tapering may change along the length of the first member. For example the tapering may be steeper (larger diameter of the first member) near the second member. The depth of penetration can also be adjusted to some degree by applying more or less pressure or torque to the fastener when fastening the device so as to insert the first member more or less into the tap hole.

The actual length of the first member can also be adjusted as desired since the fastener, by providing anchoring, allows the length of the member inserted in the hole to be actually quite short. This is not possible with standard non-fastened spouts since a certain length of insertion in the tap hole is necessary to prevent the spout from falling off too easily.

These features advantageously provide a variety of options to minimize the damage to the tree by allowing shallower tap holes and preventing damage to the bark.

It is known that the chemical composition of the sap varies as a function of the collection point within the tree. For example higher sugar content may be found in sap collected closer to the bark in some tree species. The device of the invention advantageously provides a means by which the collection point within the tree can be adjusted by the length of the fastener, the length and shape (taper) of the first member 10 or combination of these elements. For example it is possible to have trees with different tap holes depths while using identical sap collecting devices of the invention but using fasteners of different lengths to adjust the fastening to the hole dimensions. This arrangement may also enable to control the gap between the back of the tap hole and the sap collecting opening 22 to optimize sap collecting performance. Thus the design of the sap collecting device of the invention provides great flexibility for optimizing sap collection and minimizing damage to the tree.

Furthermore the possibility of having sap collecting devices with first members of different length while still being able to securely fasten the device to the tree is of great advantage to deal with trees having different bark thickness.

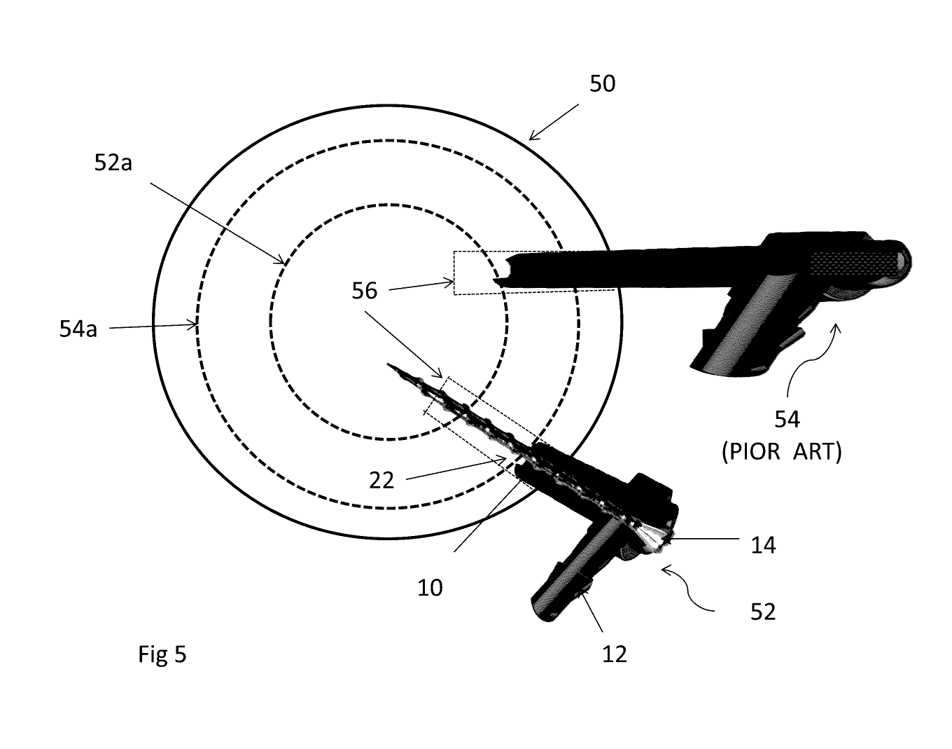

An example of some of the advantages of the invention is depicted in FIG. 5 in which a schematic horizontal cross section of a tree is shown. The perimeter of the tree is shown at 50 and a sap collecting device of the invention is generally shown at 52 in a cross section view. For comparison, a sap collecting device of the prior art is shown at 54. The dotted circles within the perimeter of the tree indicate the depth at which the first member of the respective sap collecting device penetrates within the tree. Circle 52a is for device 52 and circle 54a for device 54. As can be seen the penetration of sap collecting device 52 is much less than for the device of the prior art. This shallow penetration is made possible because of the fastener otherwise the device would fall off easily. The dotted lines 56 represent the tap hole obtained by drilling prior to inserting sap collecting devices. As can be appreciated, the first member 10 of device 52 occupies a much smaller volume in the tap hole than for the device 54 reducing obstruction of the pores or ducts within the stem thereby facilitating flow of the sap. Also the position of the sap collecting opening 22 of device 52 near the edge of the perimeter of the tree enables collection of sap with a different chemical composition, for example comprising a greater concentration of sugars.

Tap holes can have a depth of between about ½ of an inch and 2½ inches. Typically however they are about 1½ to 2 inches and the length of the first member 10 about 2 to 2½ inch with about 20 to 50% of its length inserted in the tree. On average the length of the first member in the tree will be about ½ an inch to ¾ of an inch. The balance between damage to the tree and sufficient depth to retain non-fastened spouts are usually taken in consideration to choose the dimensions. The present invention allows both shallower depth of penetration and/or shorter first member 10 to be used because of the fastening. For example the length of the first member 10 could be between about ¼ of an inch to 1½ inch allowing an insertion length in the tap hole of ¼ of an inch or less.

The sap collecting devices of the present invention can also be adapted to be used with tap holes of standard dimensions and typically having a diameter of less than 7/16 of an inch. In fact the sap collecting devices of the invention can have a first member with diameter similar to commonly used collecting devices ( 7/16 of an inch is 19/64 of an inch such as the “health” spout).

In another aspect of the invention there is provided a method for producing maple syrup. The method involves preparing a tap hole in a maple tree. As explained above the tap hole may have dimensions similar to typical tap holes in the industry that is to say about 1 to 2 inches deep with a diameter of about 7/16 inch or less. However, as described above, because of the better sap collecting device retention within the tap hole enabled by the fastening, the tap hole may also be much shallower. Tap holes of 1 inch or less deep can be prepared. Following the preparation of the tap hole the sap collecting device is inserted in the tap hole to fill an outer portion of the tap hole as schematically depicted in FIG. 5. The fastener is inserted through a bore of the sap collecting device to be lodged in the wood at the end of the tap hole to fasten the sap collecting device in the tap hole and the sap collecting device is sealed. The maple sap is collected by being drawn through the vacuum hose and ultimately concentrated to produce a syrup.

In one aspect the sealing is accomplished by the application of the force of the fastener such as to produce a sealing conformation contact between the fastener and the sap collecting device. The sealing conformation contact may involve one or more sealing members as described above.

The depth at which the sap collecting device is inserted within the tap hole can be determined based on a desired chemical composition of the sap since the chemical composition of the sap varies as a function of depth within the tree. For example it is possible to obtain sap with greater proportion of sugars nearer the outside perimeter of the tree. Thus in an embodiment the sap collecting opening of the sap collecting device may be positioned at about ½ (0.5) of an inch or less from the perimeter. In an embodiment the position can be ¼ (0.25) of an inch or less.

The method can be performed using any of the embodiments of the sap collecting device described in the present description.

Furthermore, the total depth of the tap hole itself may be selected based on desired chemical composition of the sap and/or the volume of sap desired to be collected. Sap volume control represents an advantage since while it is desirable to maximize the volume collected one may want to optimize the volume (perhaps drawing less volume in some case) out of consideration for the health of the tree. Furthermore, providing tap holes that are less deep also contributes to the control of the chemical composition of the sap by preventing sap from deeper sections of the tree to be collected.

Thus the tap hole may be drilled to about 1½ (1.5) inch depth or less or 1 inch or less.

### Example

In one embodiment there is provided a sap collecting device having a first member 10 length (including the fastener receiving end 16) of 1.265 inch with the fastener receiving end measuring 0.39 inch. The bore diameter in first member 10 is 0.187 inch and, in this example, is the same as the diameter of the bore in the fastener receiving end. The greatest outside diameter of first member 10 is 0.382 inch. The last 0.175 inch of the tap hole inserting end 15 tapers off towards sap collecting opening 22. The total outside diameter of the fastener receiving end is 0.462 inch. The largest inner diameter of opening 17 at the end of the fastener receiving end is 0.245 inch and is reduced gradually in a cone shaped manner until it reaches the diameter of the bore (0.187 inch) to accommodate the head of the fastener which is also cone shaped. The second member 12 is roughly perpendicular to first member 10 and approximately the same length. The diameter of the bore inside second member 12 is 0.187 inch and the outside diameter of the second member is 0.312 inch. In one aspect, the second member may comprise one or more barbs to help retain the collection tubing that is attached thereto when collection sap under vacuum. A typical barb would locally increase the outside diameter of second member 12 to about 0.35 inch.

The sap collecting device described in the paragraph above is used in combination with a screw (in this case a #8 wood screw) as fastener 14 having an exemplary length of 3½ inches and a conical shaped head that sealingly cooperates with the opening 17 of the fastener receiving end. Such a screw can be driven into the tree with a cordless drill, preferably with a clutch to ensure that it does not strip in the wood of the tree. Applying the tap is thus accelerated. It will be appreciated that a wood screw can easily be removed from the tree after sap collection by reversing the drive of the screw. In the embodiments shown in the Figures, the sap collecting hose can be attached to the tap before using the fastener to attach the tap to the tree, and in some cases, this can be convenient. However, it will be understood that the tap can be fastened to the tree prior to attaching the hose. The length of the screw can vary as a function of the device bore length and depth of tap hole desired. While requiring pulling for removal, nail-type fasteners can alternatively be used.

What is claimed is:

1. A device for collecting sap from a tree, comprising:
a first bore-comprising member, said first member comprising a tap hole inserting end and a fastener receiving end,
a second bore-comprising member fluidly connected to said first member at a point between said tap hole inserting end and said fastener receiving end and adapted to be connected to sap collecting tubing, and
wherein said fastener receiving end comprises an opening communicating with said bore of said first member and configured to sealingly collaborate with a fastener, said fastener adapted to fit in said bore and extend beyond said first member to fasten said device in the tap hole while allowing sap to flow in said first bore-comprising member and into said second bore-comprising member.

2. The device of claim 1 wherein said fastener receiving end has a nested configuration conforming to a head part of said fastener to provide sealing contact between said fastener receiving end and said head part of said fastener.

3. The device of claim 1 wherein said first member further comprises a fastener receiving end bore section contiguous with said opening at said fastener receiving end and having a smaller diameter than said bore of said first member.

4. The device of claim 1 wherein said fastener receiving end further comprises one or more sealing member.

5. The device of claim 4 wherein said one or more sealing member is a rib.

6. The device of claim 1 wherein said first member has a frusto-conical shape wherein said first member tapers off towards a sap collecting opening.

7. A sap collecting device kit comprising
a sap collecting device as claimed in claim 1, and a fastener configured for said sap collecting device.

8. The device of claim 7 wherein said fastener comprises a sealing member adapted to sealingly fit on said fastener receiving end.

9. The device of claim 7 wherein said fastener comprises sap flow facilitating means.

10. The device as claimed in claim 7 wherein said fastener is a screw.

11. The device as claimed in claim 10 wherein said screw and said bore of said first bore-comprising member have substantially equal diameters and wherein said screw comprises flow facilitating means.

12. A method of producing maple syrup comprising:
preparing a tap hole in a maple tree;
inserting a sap collecting device into the tap hole to fill only an outer portion of the tap hole;
inserting a fastener passing through a bore of the sap collecting device to lodge in an end of the tap hole to fasten the sap collecting device in the tap hole;
sealing the sap collecting device and drawing through a vacuum hose maple sap from the maple tree; and
concentrating the maple sap to produce a syrup.

13. The method of claim 12 wherein the sealing of the sap collecting device comprises applying a force on the fastener during fastening to form a sealing contact conformation between the fastener and the sap collecting device.

14. The method of claim 13 wherein the sealing contact conformation is between the fastener and one or more sealing members of the sap collecting device.

15. The method of claim 12 wherein the step of inserting the sap collecting device comprises determining an optimal depth for positioning a sap collecting opening of the sap collecting device based on a desired chemical composition of the sap.

16. The method of claim 12 wherein the step of inserting the sap collecting device comprises positioning a sap collecting opening of the sap collecting device at a depth of about ½ of an inch or less within the tap hole.

17. The method of claim 12 wherein the step of inserting the sap collecting device comprises positioning a sap collecting opening of the sap collecting device at a depth of about ¼ of an inch or less within the tap hole.

18. The method of claim 12 wherein the tap hole is drilled at a depth of 1 inch or less.
